(19) United States
(12) Patent Application Publication
(10) Pub. No.: US 2011/0145444 A1
(43) Pub. Date: Jun. 16, 2011

(54) ELECTRONIC DEVICE AND METHOD OF OBTAINING CONNECTION RELATIONSHIP BETWEEN INTERFACES AND PERIPHERAL DEVICES

(75) Inventor: LUNG DAI, Tu-Cheng (TW)

(73) Assignee: HON HAI PRECISION INDUSTRY CO., LTD., Tu-Cheng (TW)

(21) Appl. No.: 12/841,418

(22) Filed: Jul. 22, 2010

(30) Foreign Application Priority Data
Dec. 11, 2009 (CN) 200910311322.7

(51) Int. Cl. G06F 3/00

(52) U.S. Cl. 710/16; 710/62

(57) ABSTRACT

An electronic device includes interfaces adapted to electrically connect peripheral devices, a searching unit, an obtaining unit, a receiving unit, a comparing unit, and an output unit. Each interface has an exclusive first identifying code. Each peripheral device has an exclusive second identifying code. A one to one relationship exists between the first identifying codes and the second identifying codes. The searching unit generates a searching signal responding to user's operations. The obtaining unit obtains the first indentifying codes of the interfaces responding to the searching signal. The receiving unit receives the second indentifying codes of the peripheral devices responding to the searching signal. The comparing unit compares the first obtained identifying codes and the received second indentifying codes to determine a connection relationship between the interfaces and the peripheral devices according to the one to one relationship. The output unit delivers the connection relationship.

### BACKGROUND

1. Technical Field

The present disclosure relates to an electronic device, and particularly to a method of obtaining a connection relationship between interfaces of the electronic device and peripheral devices connected to the electronic device.

2. Description of Related Art

An electronic device commonly has a plurality of interfaces to electrically connect with a plurality of peripheral devices. However, a user may forget a connection relationship between the interfaces and the peripheral devices, and may accidently disconnect the wrong peripheral device from the electronic device.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout several views.

FIG. 1 is a block diagram of an electronic device in accordance with one exemplary embodiment.

FIG. 2 is a block diagram of an electronic device in accordance with another exemplary embodiment.

FIG. 3 is a flowchart of a method of obtaining a connection relationship between interfaces of an electronic device and peripheral devices connected to the electronic device in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

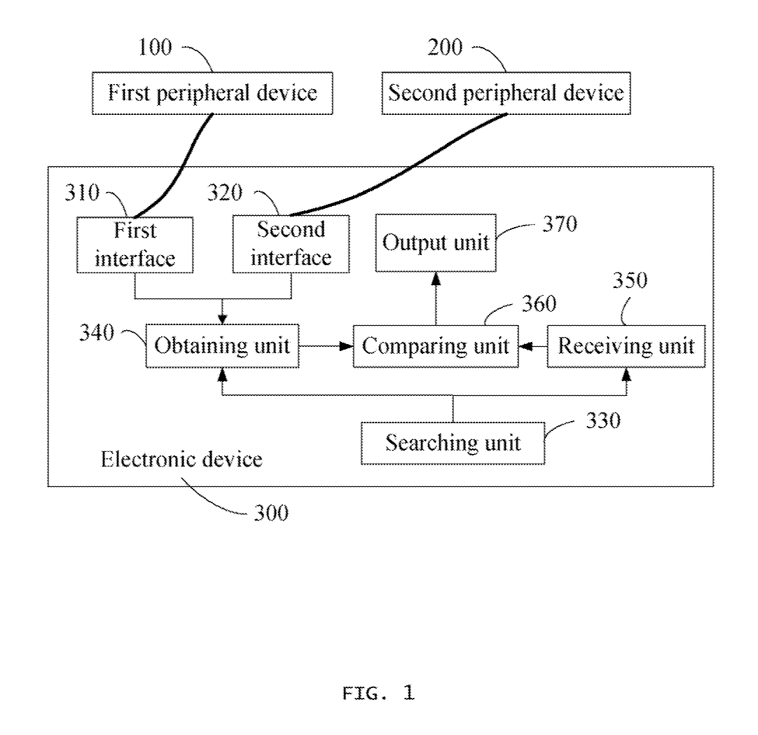

Referring to FIG. 1, an electronic device 300 has a first interface 310 for electrically connecting with a first peripheral device 100, and a second interface 320 for electrically connecting with a second peripheral device 200. The electronic device 300 also may include more than two interfaces 310, 320. The number of the peripheral devices can be adjusted corresponding to the number of the interfaces.

The first interface 310 and the second interface 320 each have an exclusive first indentifying code. The first peripheral device 100 and the second peripheral device 200 each have an exclusive second indentifying code. A one to one relationship exists between the first indentifying codes of the interface 310, 320 and the second indentifying codes of the peripheral devices 100, 200.

The electronic device 300 further includes a searching unit 330, an obtaining unit 340, a receiving unit 350, a comparing unit 360 and an output unit 370.

The searching unit 330 is used for generating a searching signal according to user's operations. The searching unit 330 may be a button arranged on the electronic device 300, and the searching signal is generated when the button is pressed. If the electronic device 300 has a displaying function, the searching unit 300 may be a menu item displayed by the electronic device 300, and the searching signal is generated when the menu item is selected.

The obtaining unit 330 is used for responding to the searching signal to obtain the first identifying codes of the interfaces 310, 320 by detecting parameters of the interfaces 310, 320.

The receiving unit 350 is used for responding to the searching signal to receive the second indentifying codes of the first peripheral device 100 and the second peripheral device 200. The receiving unit 350 may receive the second indentifying codes in a wired or wireless manner.

The comparing unit 360 is used for comparing the first identifying codes obtained by the obtaining unit 340 and the second indentifying codes received by the receiving unit 350 to determine a connection relationship between the interfaces 310, 320 and the peripheral devices 100, 200 according to the one to one relationship.

The output unit 370 is used for delivering the connection relationship between the interfaces 310, 320 and the peripheral devices 100, 200. The output unit 370 can deliver the connection relationship via at least one medium of data images and/or audible sounds. Thereby, the connection relationship can be known by a user. With these data images and/or sounds, the user will not disconnect the wrong peripheral device from the electronic device.

The electronic device 300 may include display screens for displaying the connection relationship. The electronic device 300 may also include speakers for playing audible sounds describing the connection relationship. Typically, the audible sounds are in the form of human speech.

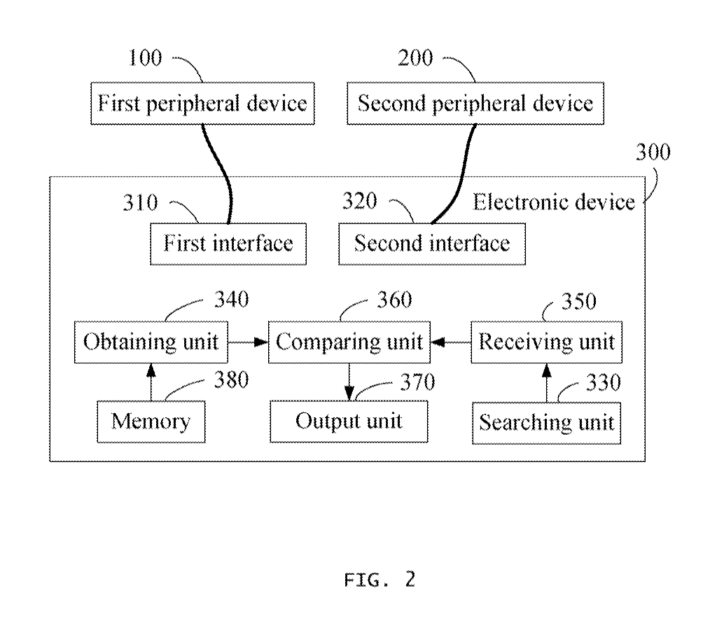

Referring to FIG. 2, in another embodiment, the electronic device 300 further includes a memory 380. The first identifying codes of the interfaces 310, 320 are stored in the memory 380 at the time of manufacturing. When the search signal is generated, the obtaining unit 340 obtains the first identifying codes of the interfaces 310, 320 by accessing the memory 380.

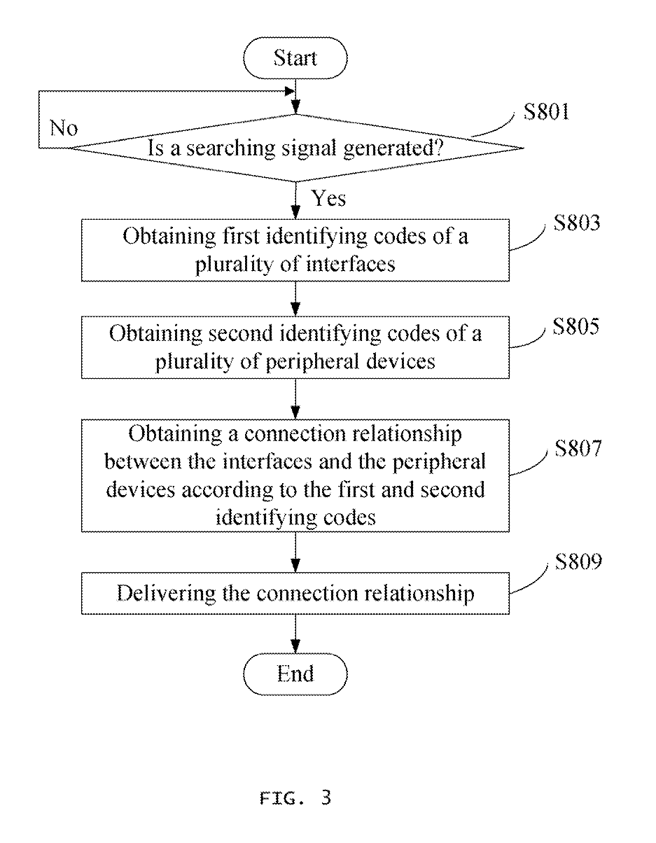

Referring to FIG. 3, a method of obtaining a connection relationship between a plurality of interfaces of an electronic device and a plurality of peripheral devices connected to the electronic device. The method includes the following steps.

In step S801, determine whether a searching signal is generated. If the searching signal is generated, step S803 is implemented. If the searching signal is not generated, step S801 is implemented again. In the embodiment, the electronic device has a button, and the searching signal is generated when the button is pressed.

In step S803, obtaining first identifying codes of the interfaces. Each interface of the electronic device has an exclusive first identifying code. The first identifying codes may be obtained by detecting parameters of the interfaces. The first identifying codes also may be stored in a memory of the electronic device at the time of manufacturing, and the first identifying codes may be obtained by accessing the memory of the electronic device.

In step S805, receiving second indentifying codes of the peripheral devices. Each peripheral device has an exclusive first identifying code. A one to one relationship exists between the first indentifying codes of the interfaces and the second indentifying codes of the peripheral devices.

In step S807, comparing the first identifying codes with the second indentifying codes to determine a connection relationship between the interfaces and the peripheral devices according to the one to one relationship.

In step S809, delivering the connection relationship between the interfaces and the peripheral devices. The connection relationship can be delivered via at least one medium of data images and/or audible sounds. Thereby, the connection relationship can be known by a user. With these data images and/or sounds, the user will not accidently disconnect the wrong peripheral device from the electronic device.

It is understood that, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device, comprising:
a plurality of interfaces adapted to electrically connect a plurality of peripheral devices to the electronic device, each interface having an exclusive first identifying code, each peripheral device having an exclusive second identifying code, and a one to one relationship existing between the first identifying codes and the second identifying codes;
a searching unit adapted to generate a searching signal responding to user's operations;
an obtaining unit adapted to obtain the first indentifying codes of the interfaces responding to the searching signal;
a receiving unit adapted to receive the second indentifying codes of the peripheral devices responding to the searching signal;
a comparing unit adapted to compare the first identifying codes obtained by the obtaining unit and the second indentifying codes received by the receiving unit to determine a connection relationship between the interfaces and the peripheral devices according to the one to one relationship; and
an output unit adapted to deliver the connection relationship between the interfaces and the peripheral devices.

2. The electronic device according to claim 1, wherein the obtaining unit obtains the first identifying codes of the interfaces by detecting parameters of the interfaces.

3. The electronic device according to claim 1, further comprising a memory adapted to storing the first identifying codes of the interfaces at the time of manufacturing, the obtaining unit obtaining the first identifying codes of the interfaces by accessing the memory.

4. The electronic device according to claim 1, wherein the output unit delivers the connection relationship via at least one medium of data images and/or audible sounds.

5. A method of obtaining a connection relationship between a plurality of interfaces of an electronic device and a plurality of peripheral devices connected to the electronic device, each interface having an exclusive first identifying code, and each peripheral device having an exclusive second identifying codes, and a one to one relationship existing between the first identifying codes and the second identifying codes, the method comprising:
determining whether a searching signal is generated;
if the searching signal is generated, obtaining the first identifying codes of the interfaces;
receiving the second indentifying codes of the peripheral devices;
comparing the first identifying codes with the second indentifying codes to determine a connection relationship between the interfaces and the peripheral devices according to the one to one relationship; and
delivering the connection relationship between the interfaces and the peripheral devices.

6. The method according to claim 5, wherein if the searching signal is not generated, the step of determining whether the searching signal is generated is further implemented again.

7. The method according to claim 5, wherein the first identifying codes are obtained by detecting parameters of the interfaces.

8. The method according to claim 5, wherein the first identifying codes are stored in a memory of the electronic device at the time of manufacturing, and the first identifying codes are obtained by accessing the memory of the electronic device.

9. The method according to claim 5, wherein the connection relationship is delivered via at least one medium of data images and/or audible sounds.

10. An electronic device, comprising:
a plurality of interfaces adapted to connect with a plurality of peripheral devices, each interface having an exclusive first identifying code, each of the plurality of peripheral devices connected to each of the plurality of interfaces, each peripheral device having an exclusive second identifying code;
a searching unit; and
a display;
wherein when a user wants to identify which peripheral device of the plurality of peripheral devices is connected to which interface of the plurality of interfaces, the searching unit searches for the first identifying codes and the second identifying codes and the result of the search is outputted to the display.

11. The electronic device according to claim 10, wherein a one to one relationship exists between the first identifying codes and the second identifying codes.
